(19) United States
(12) Patent Application Publication
(10) Pub. No.: US 2005/0235272 A1
(43) Pub. Date: Oct. 20, 2005

(54) Systems, methods and apparatus for image annotation

(75) Inventor: John V. Skinner, New Berlin, WI (US)

Correspondence Address: JAMES D IVEY, 3025 TOTTERDELL STREET, OAKLAND, CA, 94611-1742, US

(73) Assignee: General Electric Company, Waukesha, WI (US)

(21) Appl. No.: 10/829,417

(22) Filed: Apr. 20, 2004

(51) Int. Cl. G06F 9/45

(52) U.S. Cl. 717/136

(57) ABSTRACT

Systems, methods and apparatus are provided through which a non-procedural image annotation template is translated into source code, and compiled into an image annotation executable that has native computer instructions for an imaging system. In some embodiments, an image viewer on the imaging system accesses the native instructions and invokes the native instructions to annotate an image with text information. In some embodiments, the imaging system is a magnetic resonance, computer tomography, X-ray, ultrasound, or positron emission tomography imaging system.

### FIELD OF THE INVENTION

This invention relates generally to annotating images, and more particularly to annotating medical diagnostic images.

### BACKGROUND OF THE INVENTION

Images are often annotated with textual information. The textual information often provides descriptive or identifying information of the image. For example, an image is annotated with information that describes the owner or author of the image, or a title or label of the image, or a sequence number of the image. Annotation is a modification of the image to the extent that the textual information is visually perceptible in the image to a human. One example is a modification of a bit map to the extent that the bitmap visually represents the textual characters.

In medical imaging, images are generated from scans of patients. Similar to images in general, the medical images of patients are often annotated with textual information. The textual annotation includes demographics of the image, such as an identification of the patient, type of examination, hospital, date of examination, type of acquisition, type of scan, the orientation of the image, the use of special image processing filters, and/or statistics associated with regions of interest shown on the image. Types of medical images that are annotated include magnetic resonance (MR or MRI), computed tomography (CT or CAT), X-ray, ultrasound, and positron emission tomography (PET) images.

Conventional medical image annotation is performed from textual elements associated with an image. In one example, the elements are encoded according to the Digital Imaging and Communications in Medicine (DICOM) standard, such as versions 1.0, 2.0 or 3.0 of DICOM. DICOM objects encapsulate the text data, an original image. DICOM 3.0 defines twenty-four data elements in object-oriented terms. Each DICOM object has a unique tag, name, characteristics and semantics. DICOM requires conformance statements that identify de minimus data requirements. DICOM conforms to the International Organization for Standardization (ISO) reference model for network communications. The DICOM standard was developed jointly by the National Equipment Manufacturers Association (NEMA) in Rosslyn, Va. and by the American College of Radiology (ACR). DICOM is published by NEMA. The DICOM standard is also known as the ACR/NEMA standard.

Calculation of annotation in medical images in conventional systems frequently involves complex arithmetic calculations and special string operations. The calculations and operations of annotation are performed on the contents of DICOM elements associated with the image. These calculations are updated as new methods of acquiring images are developed.

The calculations and operations are hardcoded into the source code of the image viewers. The source code of the image viewers of medical imaging devices must be modified in accordance with the new calculations operations in order to provide new annotation methods in the image viewers.

Deciding how often to modify the source code of image viewers to include new annotation calculations and operations is a balance of competing interests in which every selection has a serious drawback. The competing interests are to provide frequent updates to improve the features of the systems, and to avoid modifications to the source code to reduce the cost of software maintenance on the image viewers. The decision as to how often to modify the source code of the viewers of the medical imaging devices is a selection between either reducing the frequency of viewer modifications which reduces the annual costs of upgrading but which also the effect of also reducing the frequency that the calculations and operations are improved; or increasing the frequency of viewer modifications which increases the frequency that the calculations and operations are improved, but also increases the annual costs of modifying the viewers. Modifying the source code of the image viewers with the new annotation calculations and operations to improve the image viewers while minimizing the number of modifications to the source code of the viewers are mutually exclusive goals. The decision as to how often to modify the viewer of the medical imaging devices new annotation calculations and operations is a selection between two undesirable options.

Furthermore, the viewer of each and every individual medical imaging device must be upgraded with the new annotation calculations and operations to allow the new annotation calculations to operate on each of medical imaging devices. However, upgrading each medical imaging device to include new annotation calculations and operations is a logistical challenge. The logistical challenges slow down the process of upgrading and results in circumstances where not all of the medical imaging devices are upgraded at the same time. Therefore, at any given time some medical imaging devices are upgraded and some are not. As a result, there is inconsistent image annotation among the medical imaging devices in the field. A lack of consistent annotation from one device to another in the field is distracting and less efficient to the work of the people who use the machines, such as the operator technicians, and those who review the images, such as radiologists.

Furthermore, conventional mechanisms exist to update the annotation calculations for systems based on C++ objects, but the conventional mechanism requires run-time interpreters to evaluate these expressions. Unfortunately, the run-time interpreters increase the time to load an image by a significant margin because run-time interpreters are inherently slower than systems that execute native code.

In addition, conventional mechanisms for managing annotation on imaging devices are also inconvenient to implement on imaging devices that are based on C++ objects using Java code because special interfaces that convert the Java code into C++ code are needed. The Java-to-C++ interfaces are less desirable because the mechanized interfaces often yield C++ code that is not optimized. The less than optimal code executes slower, and requires more memory to execute. Furthermore, the conversion from Java to C++ is an extra step in the process that increases the total time of processing on the imaging device. These problems reduce the value of using Java which otherwise has otherwise significant advantages.

The more sophisticated conventional image viewers are JAVA-based. These JAVA-based image viewers provide features that are more useful to the users of the viewers. Unfortunately, conventional annotation tools do not readily lend themselves to JAVA-based image viewers.

For the reasons stated above, and for other reasons stated below which will become apparent to those skilled in the art upon reading and understanding the present specification, there is a need in the art to reduce the need to modify and recompile the source code of the viewer that annotates the image on imaging devices in order to update the calculations and operations of the annotation method. Furthermore, there is a need to reduce inconsistent image annotation among medical imaging devices in the field. There is also a need to reduce the need for run-time interpreters of C++ source code on medical imaging devices to support the annotation of images. In addition, there is also a need to reduce the requirement for Java-to-C++ interfaces on the medical imaging devices to support the annotation of images. Furthermore, there is need in the art for image annotation tools that lend themselves to JAVA-based image viewers.

### BRIEF DESCRIPTION OF THE INVENTION

The above-mentioned shortcomings, disadvantages and problems are addressed herein, which will be understood by reading and studying the following specification. Systems, methods and apparatus are described that allow deployment of new annotation calculations and operations without modifying the source code of the image viewing software, without the inefficiencies of run-time interpreters, and that expedite the development of Java based image viewers.

In one aspect, a translator translates a non-procedural image annotation template into procedural image annotation source code. A compiler compiles the procedural image annotation source code into an annotation presentation description (APD) having computer instructions for image annotation that are native to an imaging system.

In another aspect, an image viewer invokes execution of the annotation instructions in the APD on an imaging system, thus prompting annotation of an image using data from an image annotation object, to create an annotated image. The annotation instructions are native to the imaging system, thus interpreting the annotation instructions on the imaging system is not required; therefore, a run-time interpreter is not required to execute the annotation instructions. The need to rewrite the image viewer to include annotation instructions is reduced by packaging the annotation instructions in the APD for ready execution by the imaging system without changes to the imaging viewer. The convenient packaging of the annotation instruction more readily and conveniently allows for consistent deployment of annotation calculations and operations among medical imaging systems.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of a system level overview of an embodiment of a development system that provides an image annotation executable;

FIG. 2 is a block diagram of a system level overview of an embodiment of a medical imaging system that uses the image annotation executable;

FIG. 3 is a flowchart of a method to generate an image annotation executable, according to an embodiment;

FIG. 5 is a flowchart of a method to annotate an image using an image annotation executable and an image annotation object, according to an embodiment;

FIG. 6 is an object-oriented computed tomography medical imaging system is system that is readily suitable imaging using DICOM objects that specify the annotation text and image, according to an embodiment;

FIGS. 7-8 are UML diagrams of classes that compose a translator, according to an embodiment;

FIG. 9 is a flowchart of a method of a parsing phase of a Java-based translator, according to an embodiment;

FIG. 10 is a flowchart of a method of a translating phase of a Java-based translator, according to an embodiment;

FIG. 11 is a flowchart of a method of filling hash tables representing elements in the translating phase in FIG. 11 of a Java-based translator, according to an embodiment;

FIG. 12 is a block diagram of a hardware and operating environment in which different embodiments can be practiced, according to an embodiment;

FIG. 12 is a block diagram of a hardware and operating environment in which the development system in FIG. 1 can be practiced, according to an embodiment; and

FIG. 13 is a block diagram of a hardware and operating environment in which the imaging system in FIG. 2 can be practiced, according to an embodiment.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The detailed description is divided into six sections. In the first section, system level overviews are described. In the second section, methods of embodiments are described. In the third section, apparatus are described. In the fourth section, Java implementations are described. In the fifth section, the hardware and the operating environment in conjunction with which embodiments may be practiced are described. Finally, in the sixth section, a conclusion of the detailed description is provided.

### System Level Overviews

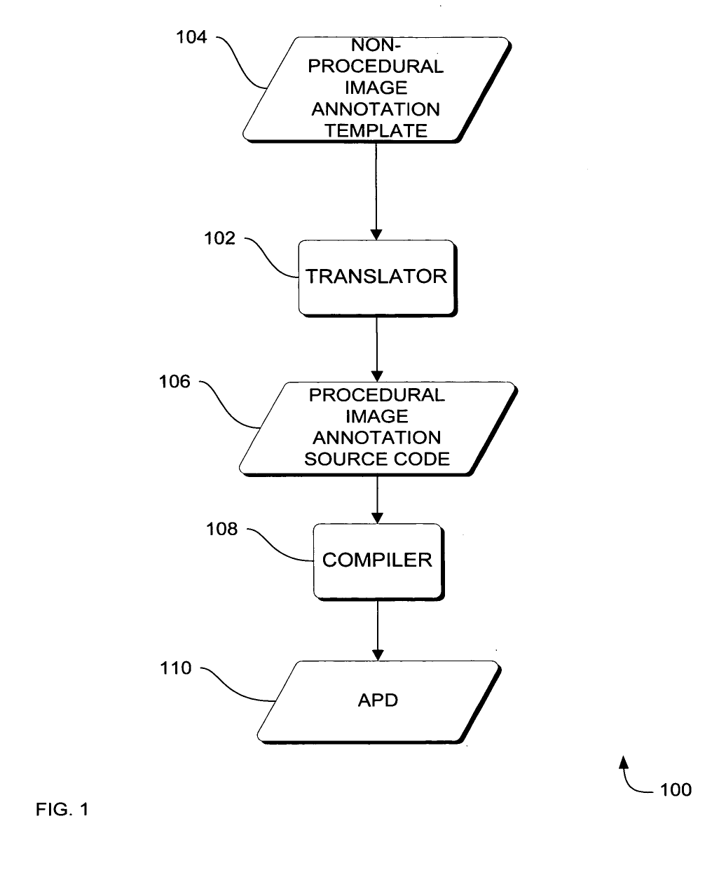

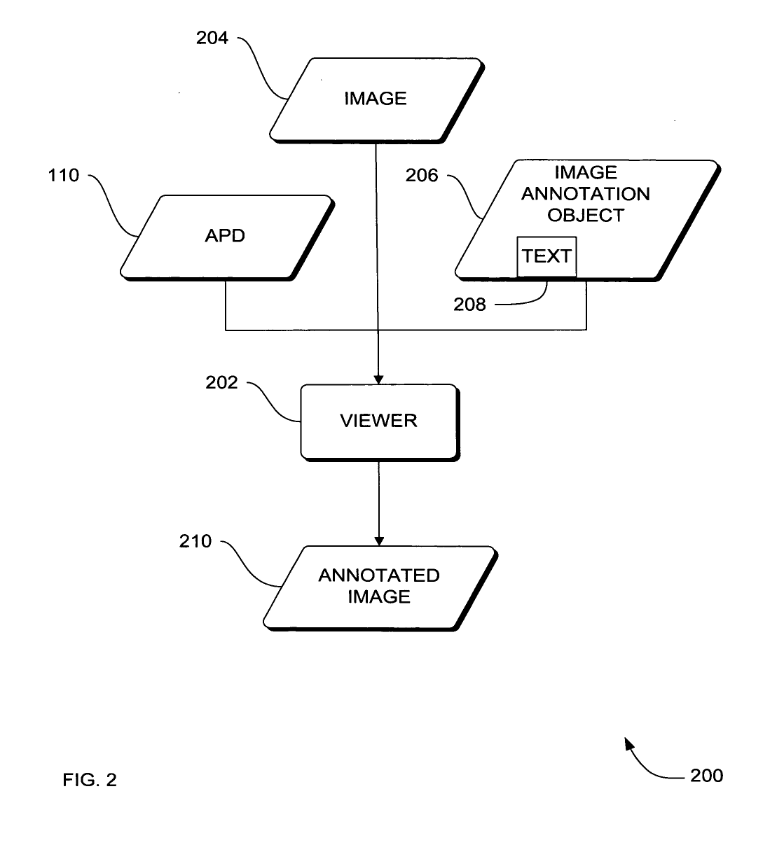

FIG. 1 is a block diagram of a system level overview of an embodiment of a development system 100 that provides an image annotation executable that includes annotation calculations and operations. FIG. 2 is a block diagram of a system level overview of an embodiment of an imaging system 200 that uses the image annotation executable that has the annotation calculations and operations. Systems 100 and 200 allow deployment of annotation calculations on imaging system 200 without upgrading the image viewer on imaging system 200, without, the inefficiencies of run-time interpreters to annotate images on imaging system 200, while allowing for faster development of image viewers for the imaging system 200.

System 100 includes a translator 102. The translator 102 receives a non-procedural image annotation template 104 and translates the template 104 into procedural image annotation source code 106. The non-procedural image annotation template 104 includes non-procedural expression of calculations and operations to annotate an image with embedded text. The non-procedural image annotation template 104 also includes metadata that describes formatting of text on the image.

Content of the non-procedural image annotation template 104 is written in a language that does not require procedural operations. Rather, the language includes expressions that typically can be written in a high level language such as C++ or Java as a single expression and that is devoid of procedural control flow constructs such as “for” or “while” language constructs. In contrast, the procedural image annotation source code 106 includes calculations and operations that does have procedural control flow constructs such as “for” or “while” language constructs.

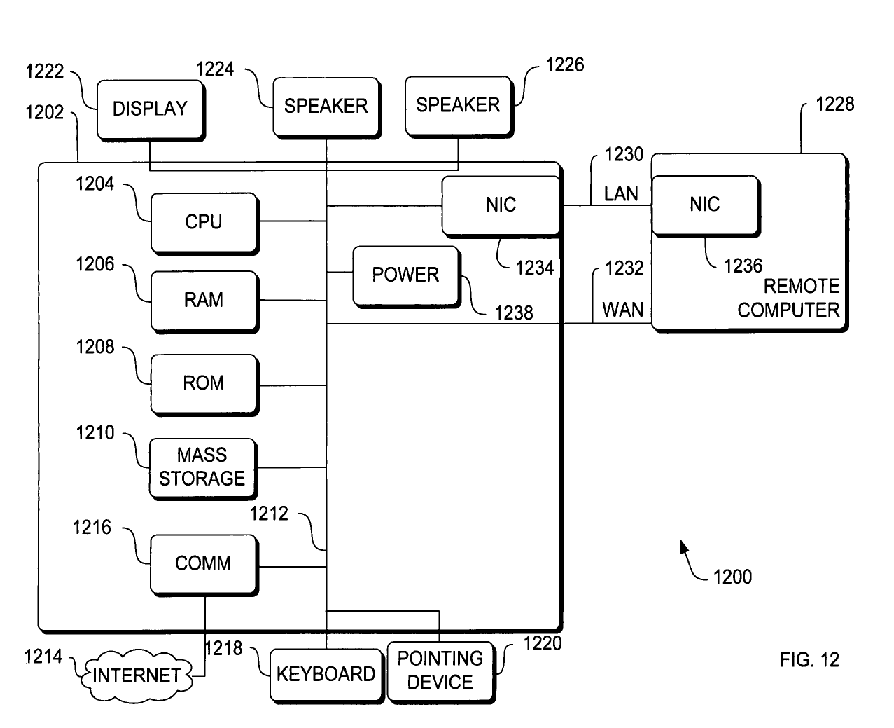

System 100 also includes a compiler 108 that receives the procedural image annotation source code 106 and compiles the source code into an annotation presentation description (APD) 110. The APD 110 includes the metadata that describes formatting of text on the image. In some embodiments, the compiler 108 is a standard off-the-shelf compiler for a standard version of JAVA or C++, such as a C++ compiler manufactured by Objective C++. The compilation is targeted to the instruction set of the processor of imaging system 200; thus the APD 110 includes computer instructions that are native to imaging system 200 to calculate annotations. More generally, the APD 110 is an image annotation executable; an executable whose function is image annotation. In some embodiments, the APD 110 is transferred to the imaging system 200 in FIG. 2. Embodiments of system 100 operate in multi-processing, multi-threaded operating environments on a computer, such as computer 1202 in FIG. 12.

Turning to FIG. 2, system 200 includes an image viewer 202 that receives the APD 110, an image 204 and an image annotation object 206. The APD 110 includes or encapsulates computer instructions that are native to system 200. Because the instructions are native to system 200, the instructions do not need to be interpreted before execution. Accordingly, the imaging system 200 does not require a run-time interpreter to execute the annotation calculations and operations. Thus system 200 reduces the need for run-time interpreters of source code on imaging system 200 to support the annotation of image 204.

The viewer 202 invokes execution of the native computer instructions contained in, and received from, the APD 110. Execution of the native computer instructions uses data from the image 204 and the image annotation object 206. Operands to the native computer instructions include the text 208 in the image annotation object 206. Thus viewer 202 generates an annotated image 210 that is annotated with text 208 from the image annotation object 206.

Text 208 includes information that describes the owner of the image, a title or label of the image, a sequence number of the image, or demographics of the image, such as an identification of the patient, type of examination, hospital, date of examination, type of acquisition, type of scan, the orientation of the image, the use of special image processing filters, and/or statistics associated with regions of interest shown on the image.

System 200 obviates the need to rewrite the viewer 202 to include the annotation calculations and operations is reduced by packaging or encapsulating the annotation calculations and operations in APD 110 in system 100 and invoking execution of the annotation calculations and operations in the APD 110 by the viewer 202 in imaging system 200.

In some systems, integration between the APD 110 and the viewer is further enhanced by compiling the APD as a plug-in component to the viewer 202 or as a dynamic link library (DLL) shared library that is accessible to the viewer 202. The viewer plug-in component is a file containing instructions used to alter, enhance, or extend the operation of the viewer. Regardless of the particular implementation of the APD as a plug-in or as a DLL, the speed of software development of viewer 202 is improved because the annotation calculations and operations are encapsulated separately from the viewer, which simplifies and thus improves the speed of the process of software development of viewer 202.

The image 204 may be encoded in accordance with a conventional graphic encoding scheme such as DICOM, JPEG, GIF, TIFF, BMP, PCX, TGA, PNG, SVG, ANALYZE (published by the Mayo Clinic of Rochester, Minn.), MINC, AFNI, MPEG and Quicktime, or the image may a bitmap. The image annotation object 206 encapsulates text 208. The metadata describes how the text 206 is to be formatted on the image 204. The image annotation object 206 conforms to an image annotation standard, such as DICOM, the Papyrus standard published by the the Numerical Unit of Imagery in France (based on DICOM), General Electric MRI/LX, General Electric MRI/Genesis 5, General Electric MRI/Signa, General Electric Scanditronix (4096 PET format), and Interfile published by the Society of Nuclear Medicine in Reston, Va. In the instances where the image annotation object 206 is a DICOM compliant object, the original image 204 is typically encapsulated in the image annotation object 206. The original image 204 may or may not have annotations from previous processing.

In some embodiments, the APD 110, the image annotation executable, is received from system 100, through at least one of a number of conventional means of data distribution, such as the Internet or a removable magnetic or optical computer-accessible storage medium, such as a CD-ROM. Thus, system 100 and system 200 can be physically remote from each other.

As described above, the viewer 202 invokes execution of the native computer instructions contained in the APD 110 and uses data from the image 204 and the image annotation object 206. Thus viewer 202 generates an annotated image 210 that is annotated with text 208 from the image annotation object 206. The need to rewrite the viewer 202 on imaging system 200 to include the annotation calculations and operations is reduced by packaging the annotation calculations and operations in APD 110 by system 100 and invoking execution of the annotation calculations and operations in the APD 110 by the viewer 202 in imaging system 200.

Furthermore, systems 100 and 200 reduce inconsistent deployment of annotation calculations and operations among medical imaging devices in the field. The annotation calculations and operations are packaged in the APD 110 in system 100 and executed by a viewer 202 on imaging system 200. This is a more convenient process than the conventional systems that require the source code of the viewer 202 to be updated. Thus changes in annotation calculations and operations packaged in APD 110 by system 100, and distributed to system 200 for ready execution by system 200 without changes to viewer 202, more readily and conveniently allows for consistent deployment of annotation calculations and operations among medical imaging systems.

The system level overview of the operation of embodiments if an image annotation system has been described in this section of the detailed description. While the systems 100 and 200 are not limited to any particular development system 100, translator 102, non-procedural image annotation template 104, procedural image annotation source code 106, compiler 108, APD 110, imaging system 200, image viewer 202, image 204, image annotation object 206, text 208, and annotated image 210. For sake of clarity a simplified development system 100, translator 102, non-procedural image annotation template 104, procedural image annotation source code 106, compiler 108, APD 110, imaging system 200, image viewer 202, an image 204, image annotation object 206, text 208, and annotated image 210 have been described.

### Methods of an Embodiment

In the previous section, system level overviews of the operation of embodiments were described. In this section, particular methods performed by the computers of such an embodiment are described by reference to a series of flowcharts. Describing the methods by reference to a flowchart enables one skilled in the art to develop such programs, firmware, or hardware, including such instructions to carry out the methods on a processor of the of suitable computers executing the instructions from computer-readable media. Methods 300-400 are performed by a program executing on, or performed by firmware or hardware that is a part of, a computer, such as computer 1202 in FIG. 12.

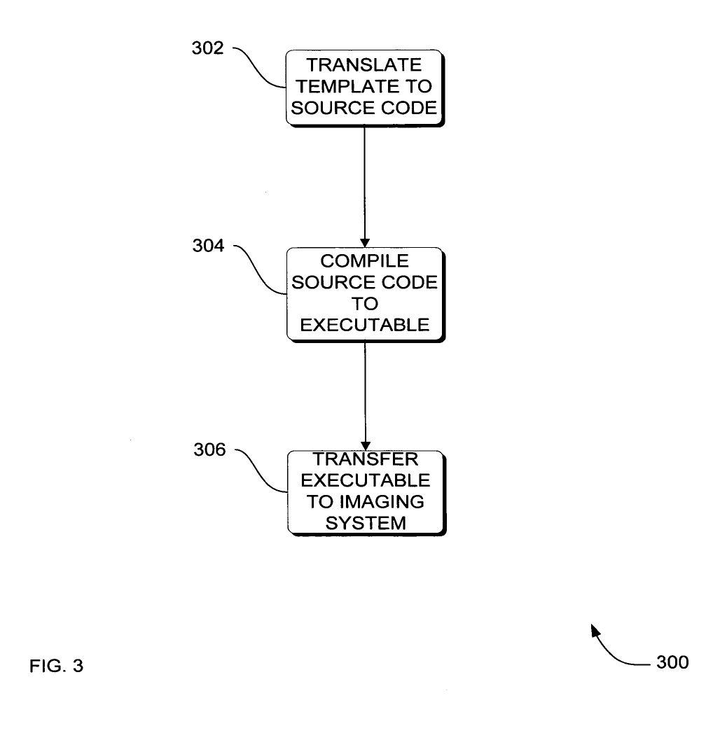

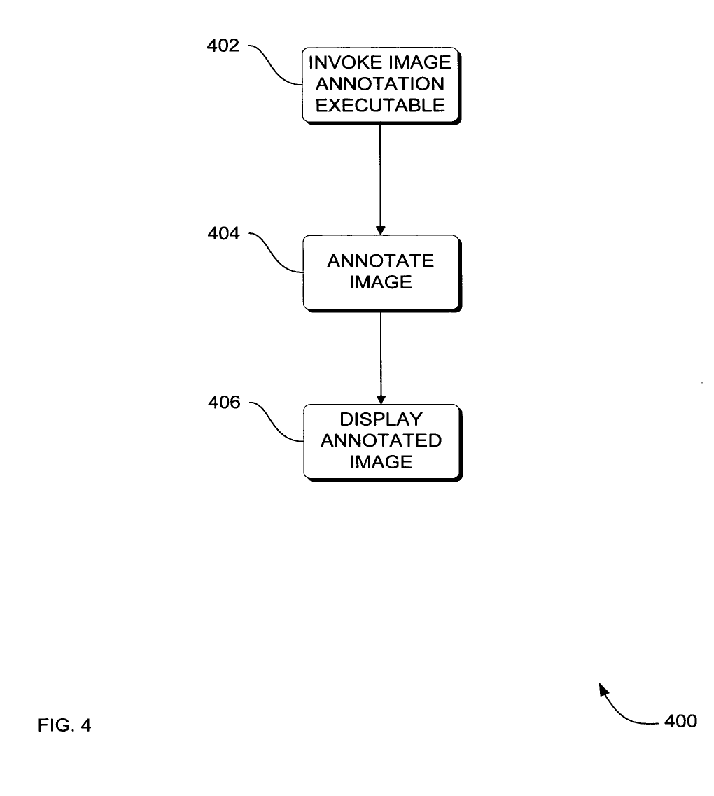

FIG. 3 is a flowchart of a method 300 performed by a computer according to an embodiment. Method 300 generates an image annotation executable, such as an annotation presentation description (APD) 110, from a non-procedural image annotation template 104 to annotate an image 204.

In method 300 the non-procedural image annotation template 104 is translated 302 into the image annotation source code 106. In some embodiments the translating 302 is performed by translator 102 in FIG. 1. In some embodiments, the non-procedural image annotation template 104 includes a mixture of extended markup language (XML) and conventional numerical expressions based on C language syntax, and is translated 302 into a standard source code language such as a standard version of JAVA, C++ or Data Format Independence (DFI) developed by General Electric Corporation.

Method 300 also includes compiling 304 an image annotation source code 106 into an image annotation executable 110. In some embodiments the compiling 304 is performed by compiler 108 in FIG. 1. The compiling 304 includes targeting the compilation to an instruction set of a processor of an imaging system, such as imaging system 200. Thus the image annotation executable includes computer instructions that are native to imaging system 200 to calculate annotations and can be performed by the processor of imaging system 200 without run-time interpretation. Therefore, method 300 reduces the need for run-time interpreters of source code on imaging system 200 to support the annotation of images.

Method 300 includes transferring 306 the APD 110 to an imaging system 200. The transfer is performed through at least one conventional means of data distribution, such as the Internet or a removable magnetic or optical computer-accessible storage medium, such as a CD-ROM.

Method 300 reduces the need for run-time interpreters of source code on imaging system 200 to support the annotation of images. The computer instructions in the image annotation executable 110 that are native to the processor of imaging system 200 do not require run-time interpretation on imaging system 200. The absence of run-time interpretation increases the speed of execution of the image annotation executable on system 200 and reduces the number of times that expressions in the image annotation executable are evaluated to only when the variable data that each expression depends on has changed its value since a previous evaluation.

FIG. 4 is a flowchart of a method 400 performed by a computer according to an embodiment. Method 400 annotates an image 204 using an image annotation executable 110 and an image annotation object 206, and then allows the annotated image to be viewed. In some embodiments, method 400 is performed by a medical imaging system, such as medical imaging system 200.

Method 400 includes invoking 402 executable instructions in the image annotation executable. The executable instructions include annotation calculations and operations. One example of an image annotation executable is the annotation presentation description (APD) 110 in FIG. 1. The executable instructions are native to the processor of the computer that performs method 200. Text 208 operands are used during the execution of the native computer instructions. The Text 208 operands are obtained from the image annotation object 206.

Method 400 also includes generating 402 an annotated image 210 that is annotated with the text 206 from the image annotation object 206. Method 400 also includes displaying 406 the annotated image 210 on a visual display in an image viewer, such as a browser. The annotated image 210 can then be viewed by a radiologist or other medical worker in the diagnosis and treatment of illness.

Viewer 202 on imaging system 200 does not need to be rewritten when annotation calculations and operations change by packaging the annotation calculations and operations in APD 110 in system 100 and invoking execution of the annotation calculations and operations in the APD 110 by the viewer 202 in imaging system 200.

Method 400 reduces the need for run-time interpreters of source code on imaging system 200 to support the annotation of images. The computer instructions in the image annotation executable that are native to the processor of imaging system 200 do not require run-time interpretation on imaging system 200 which increases the speed of execution of the image annotation executable on system 200 and reduces the number of times that expressions in the image annotation executable are evaluated to only when the variable data that each expression depends on has changed its value since a previous evaluation.

In some embodiments, methods 300-400 are implemented as a computer data signal embodied in a carrier wave, that represents a sequence of instructions which, when executed by a processor, such as processor 1204 in FIG. 12, cause the processor to perform the respective method. In other embodiments, methods 300-400 are implemented as a computer-accessible medium having executable instructions capable of directing a processor, such as processor 1204 in FIG. 12, to perform the respective method. In varying embodiments, the medium is a magnetic medium, an electronic medium, or an optical medium.

### Apparatus

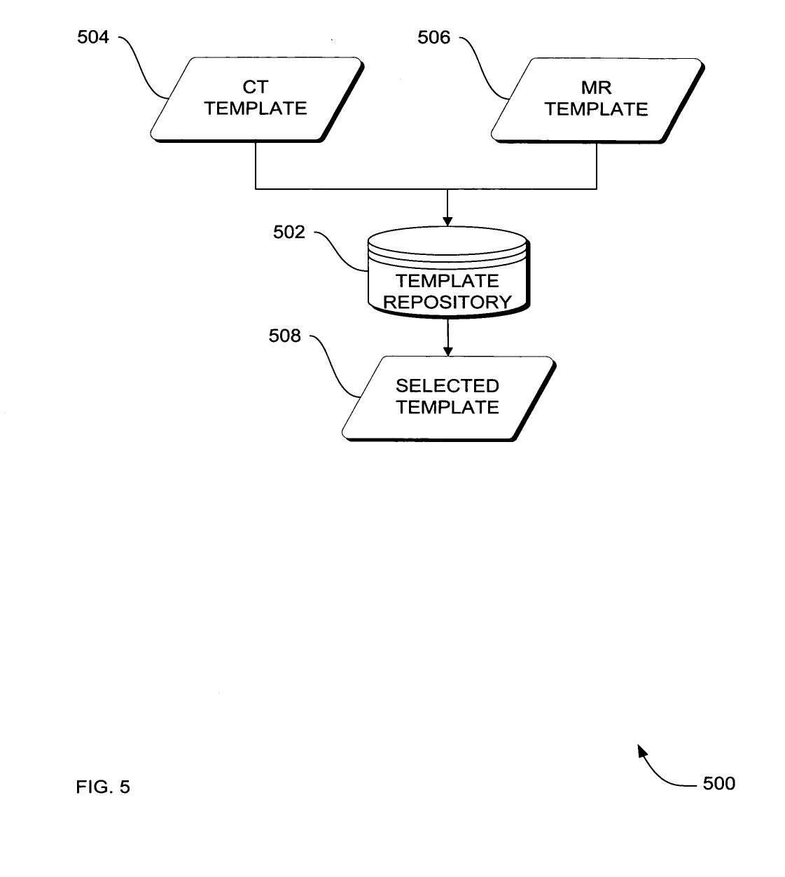

Turning to FIG. 5, implementations of development system 100 are described. The elements in system 500 are additional to the elements in development system 100 described in FIG. 1.

Medical imaging system 500 includes a template repository 502 that is operable to store one or more non-procedural image annotation templates 104. The template allows multiple non-procedural image annotation templates 104 to be centrally stored and retrieved, thus allowing the entire organization that manages the template repository 502 to have access to non-procedural image annotation templates 104 that have been stored previously in the template repository 502.

Non-procedural image annotation templates 104 of a wide variety of attributes can be stored and retrieved from the template repository 502. Examples include a computed tomography (CT) non-procedural image annotation template 504 that is customized for CT applications, and a magnetic resonance (MR) non-procedural image annotation template 506 that is customized for MR applications.

Non-procedural image annotation templates that are retrieved from the template repository 502 are a selected non-procedural image annotation template 508. The selected non-procedural image annotation template 508 can be used as the non-procedural image annotation template 104 in development system 100.

System 500 is particularly useful in providing economies of scale in environments where more than one image viewer program must be updated with new annotation calculations and operations. In that case, the template repository 502 facilitates the multiple use of a non-procedural image annotation template 104, thus leveraging the investment in creating the non-procedural image annotation template 104.

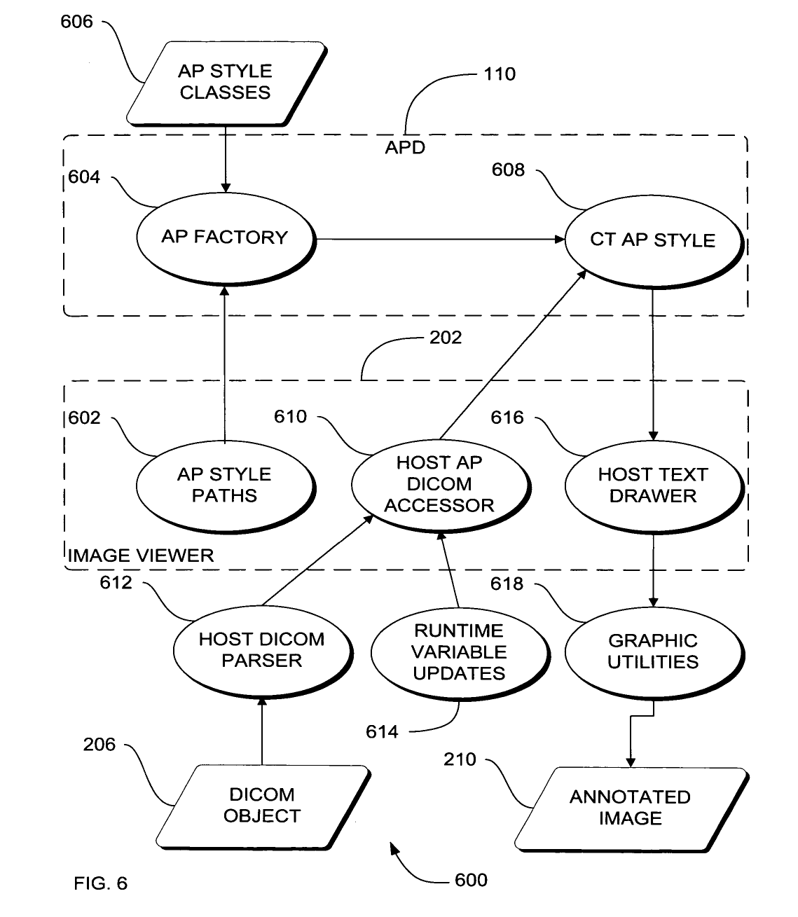

Turning to FIG. 6, implementations of medical imaging system 200 are described. In FIG. 6, a computed tomography (CT) medical imaging system 600 is an object-oriented system that is readily suitable for CT imaging using DICOM objects to specify the annotation text and image. An annotation presentation (AP) Style Paths object 602 in the image viewer 202 invokes one or more methods in an AP Factory object 604 in the APD 110. One of the methods that is invoked is the AP Factory object 604 is a method to select a style class object that is appropriate for CT imaging from AP Style Classes object 606, such as CT AP Style object 608. When the CT AP Style object 608 is selected, the CT AP Style object 608 is subsequently instantiated.

A host AP DICOM Accessor object 610 in the image viewer 202 receives parsed annotation data and an image 204 from the DICOM object 206 through a host DICOM parser. The parsed annotation data includes text 208. The host AP DICOM Accessor object 610 forwards the image 204, and text 208 to the CT AP Style object 608.

A host DICOM parser 612 represents a standard DICOM parser. The image viewer 202 uses the DICOM parser 612 to read select information from the DICOM object 206. Upon request, the DICOM parser 612 supplies the select information to the Host AP DICOM Accessor 610.

A Runtime Variable Updates object 614 represents text that is supplied by the image viewer 202 to the CT AP Style object 608. The text represents information regarding the viewing parameters such as zoom or pan or filters.

The CT AP Style object 608 forwards the image 204 and text 208 to a host text drawer 616 in the image viewer 202, which forwards the image 204, and text 208 to a graphic utilities object 618. Typically, the graphic utilities object 618 is an object that is native to an operating system that is running on the CT medical imaging system 600, such as Microsoft Windows® or Sun Microsystems Solaris®. The graphic utilities object 618 generates the annotated image 210.

CT medical imaging system 600 reduces the need to rewrite the viewer 202 to include the annotation calculations and operations by packaging or encapsulating the annotation calculations and operations in APD 110 by system 100 and invoking execution of the annotation calculations and operations in the APD 110 by the viewer 202 in CT medical imaging system 600. CT medical imaging system 600 does not require a run-time interpreter to execute the annotation calculations and operations. Changes in annotation calculations and operations packaged in APD 110 for ready execution by CT medical imaging system 600 without changes to viewer 202, more readily and conveniently allows for consistent deployment of annotation calculations and operations among medical imaging systems.

In particular, economies of scale accrue in environments where more than one image viewer program must be updated with new annotation calculations and operations. In that case, an APD 110 can be created once and used by multiple image viewers, thus leveraging the investment in creating the APD 110.

### Java Implementation

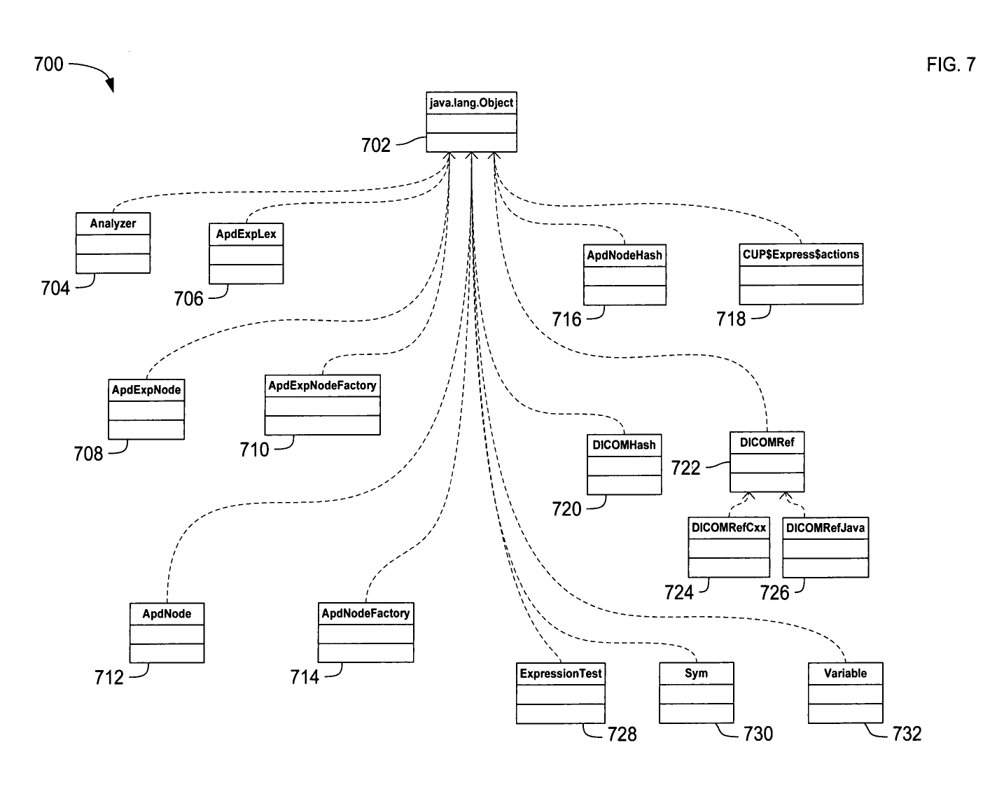

Referring to FIGS. 7-9, a Java-based implementation is described in conjunction with the system overview in FIGS. 1-2 and the methods described in conjunction with FIGS. 3-4. FIGS. 7-9 use the Unified Modeling Language (UML), which is the industry-standard language to specify, visualize, construct, and document the object-oriented artifacts of software systems. In the figures, a hollow arrow between classes is used to indicate that a child class below a parent class inherits attributes and methods from the parent class. The dashed lines indicate dependency through inheritance.

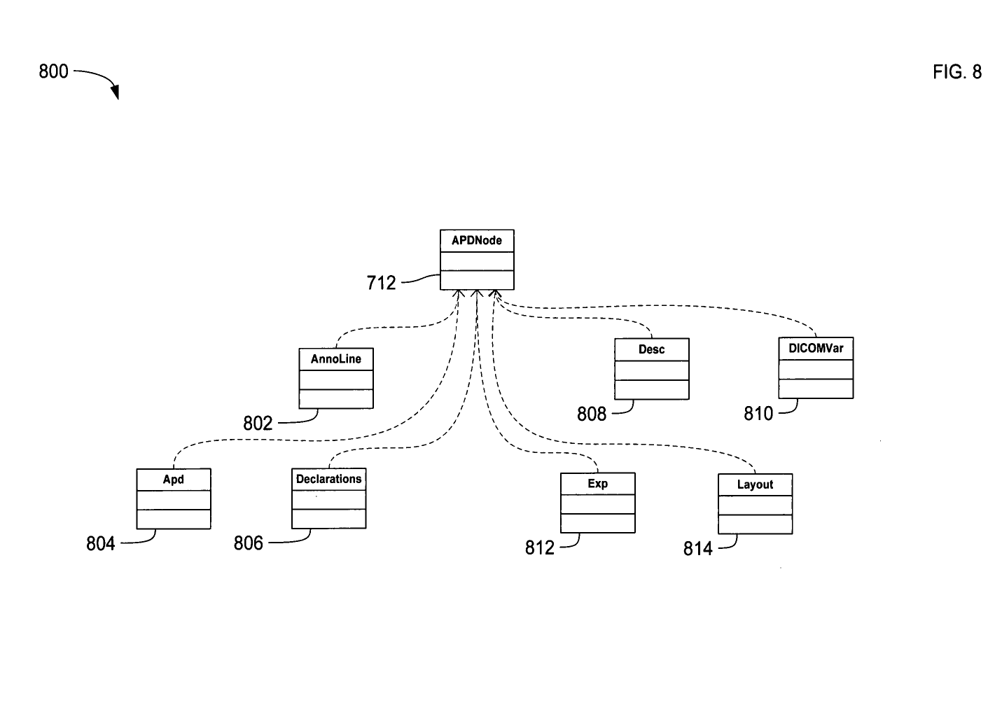

FIG. 7 describes classes 700 in the translator 102 in FIG. 1 that are child classes of the class java.lang.Object. FIG. 8 describes classes 800 in the translator 102 that are child classes of ApdNode 712. Table 1 below describes classes and the function of each class in the translator 102:

TABLE 1

| FIGURE | CLASS | CLASS |
|---|---|---|
| REFERENCE | NAME | DESCRIPTION |
| 704 | Analyzer | An iterator for the expression tree of the |
| | | non-procedural image annotation template |
| | | 104. |
| 706 | ApdExpLex | Serves as the lexical analyzer for the |
| | | freetext expressions in APD. |
| 708 | ApdExpNode | A base class for the expression nodes that |
| | | represent the expressions for the <set> |
| | | expression. |
| 710 | ApdExpNodeFactory | Constructs the appropriate concrete class of |
| | | objects depending on whether C++ or Java |
| | | code is to be produced. |
| 712 | ApdNode | Base class of all the XML elements in |
| | | APD. |
| 714 | ApdNodeFactory | Produces the appropriate class of |
| | | ApdNodes given the output type of the translator. |
| 716 | ApdNodeHash | Utility class for associating ApdNodes with |
| | | strings. This is principally used to find the |
| | | correct apdNode for the XML element |
| | | name being parsed. This ApdNode then |
| | | performs semantic checking and |
| | | construction of an ApdNode subclass. |
| 718 | CUP$Express$actions | Cup generated class to encapsulate user |
| | | supplied Action code. |
| 720 | DICOMHash | An associative container for string keys to |
| | | DICOM variables. |
| 722 | DICOMRef | Represents a reference to a DICOM |
| | | element within an expr. |
| 724 | DICOMRefCxx | Emit C++ code to retrieve the value of one |
| | | DICOM reference. |
| 726 | DICOMRefJava | Emit Java code to retrieve the value of one |
| | | DICOM reference. |
| 728 | ExpressionTest | Test a single expression. |
| 730 | Sym | CUP generated class containing symbol |
| | | constants. |
| 732 | Variable | Represents any type of variable instance |
| | | that holds a single value. The dependency |
| | | on this value is carefully tracked to assure it |
| | | is evaluated prior to references. Therefore |
| | | subscripted DICOM references are tracked |
| | | by unique subscript value. |
| 802 | AnnoLine | Represents the annoLine XML element. |
| 804 | Apd | Serves both as the syntax tree not for but |
| | | also as the control of writing the APD 110. |
| 806 | Declarations | Represents all declarations defined within |
| | | the <declarations> section. This class also |
| | | provides abstract method for producing |
| | | declarations in the specific translated |
| | | language. |
| 808 | Desc | Represents all of the translations for one |
| | | desc XML element. |
| 810 | DICOMVar | Represents one DICOM variable in the |
| | | declarations section of the APD 110. |
| 812 | Exp | Represents a set of expressions and table |
| | | definitions for either the global set or within |
| | | a set for the <given> clause. |
| 814 | Layout | Represents the section that describes the |
| | | location of each element of annotation. It |
| | | also contains the main contributing emitter |
| | | that fills the build( ) method of an ApStyle |
| | | subclass. |

Objects instantiated by the classes in FIGS. 7-8 read the non-procedural image annotation template 104. The non-procedural image annotation template 104 is encoded in a notation that is directed towards suitability in creating an annotation presentation description (APD) 110. The notation is known as an APD Language.

The Java-based systems 700 and 800 reduce the need for Java-to-C++ interfaces on the imaging system, such as systems 200, 400 and 500 to support the annotation of images. Also, because the methods use Java, no interface between Java components based on methods 900, 1000 and 1100 and other Java components of systems imaging 200 is needed to support the annotation of images.

The APD Language is based on the Extensible Markup Language (XML) standard, XML being published by the World Wide Web Consortium (W3C), at the Massachusetts Institute of Technology, Laboratory for Computer Science. The APD language includes structured free text used for expressions. The XML portion is defined below using Document Type Definition (DTD). The free text is defined using a YACC-like notation. YACC is a standard parser on UNIX systems, and is an acronym for “yet another compiler compiler.” The APD syntax is defined in Table 2 as follows:

TABLE 2

```
<!ELEMENT apd (version,
                declarations,
                expressions?,
                allowExtender?,
                layout,
                groupName+)>
    <!ATTLIST version
      syntax CDATA #REQUIRED
        content CDATA #REQUIRED>
    <!ELEMENT declarations (dicomVar| runtimeVar)*>
    <!ATTLIST dicomVar
      name CDATA #REQUIRED
        group CDATA #REQUIRED
        element CDATA #REQUIRED
        creator CDATA ””
        type (string|float|int|sequence #REQUIRED)>
    <!ATTLIST runtimeVar
        name CDATA #REQUIRED
        type (string|float|int #REQUIRED)
        initial CDATA >
        <!ATTLIST i18n
          lang (en_US|fr|de|it|es_MX|pt_BR|zh|kr|ja) en_US
          string= CDATA>
        <!ELEMENT groupName groupName* i18n+ >
        <!ATTLIST groupName
          name CDATA #REQUIRED
          number CDATA 0>
    <!ELEMENT allowExtender (#PCDATA) >
    <!ATTLIST allowExtender
    isTrue CDATA #REQUIRED>
    <!ELEMENT layout (annoLine)*>
    <!ELEMENT annoLine (seg)+>
    <!ATTLIST annoLine
      location (N|S|E|W|NW|NE|SW|SE|C) #REQUIRED
        line CDATA #REQUIRED
        dir (H|V) H
        font (normal|bold ) normal
        size (small|medium|large|verylarge) medium
        color CDATA #ffffff
        useShadow (true|false) true>
    <!ELEMENT seg desc?>
    <!ATTLIST seg
      exp CDATA #REQUIRED
        group CDATA ””
        priority CDATA 10 “”>
    <!ELEMENT desc (i18n)+>
    <!ELEMENT expressions ((table|set)*)>
    <!ELEMENT table (entry+)>
    <!ATTLIST table
        name CDATA #REQUIRED
        type (int|string|i18n) string>
    <!ATTLIST entry
        i CDATA
        v CDATA>
    <!ELEMENT set (#PCDATA)>
    <!ATTLIST set
    name CDATA #REQUIRED>
```

In the APD Language structure described in Table 2, the <version> element defines the version information for the APD file. The <i18n> element provides internationalized strings. The <declarations> element marks the portion of the APD that defines all variables that can be referenced by annotation expressions. The variables are introduced either from the DICOM object, or from the application at run-time. The <seg> element defines one segment of text on one line of annotation. The <groupName> element defines a group of annotation that the user can turn on and off. The name of a group is referenced by the groups attribute in the <seg> element. The <expressions> element marks the section of the APD that defines the values of variables referenced by elements in the <layout> section, and <set> elements. The layout element marks the section of the APD that defines the placement of annotation text on the image. The <dicomVar> provides an alias name for DICOM tags in the file. The <runtimeVar> element defines the name and type of one run-time variable. The <layout> element defines the section of the file that contains the annotation layout information. The <annoLine> contains the placement of one line of annotation on the image. The <desc> element provides the description for the segment. The <table> element defines a lookup table that can be defined and used for internationalization and for convenience. Each <entry> within the table associates a value with an index. The <set> elements define how to compute the value for each <set> variable.

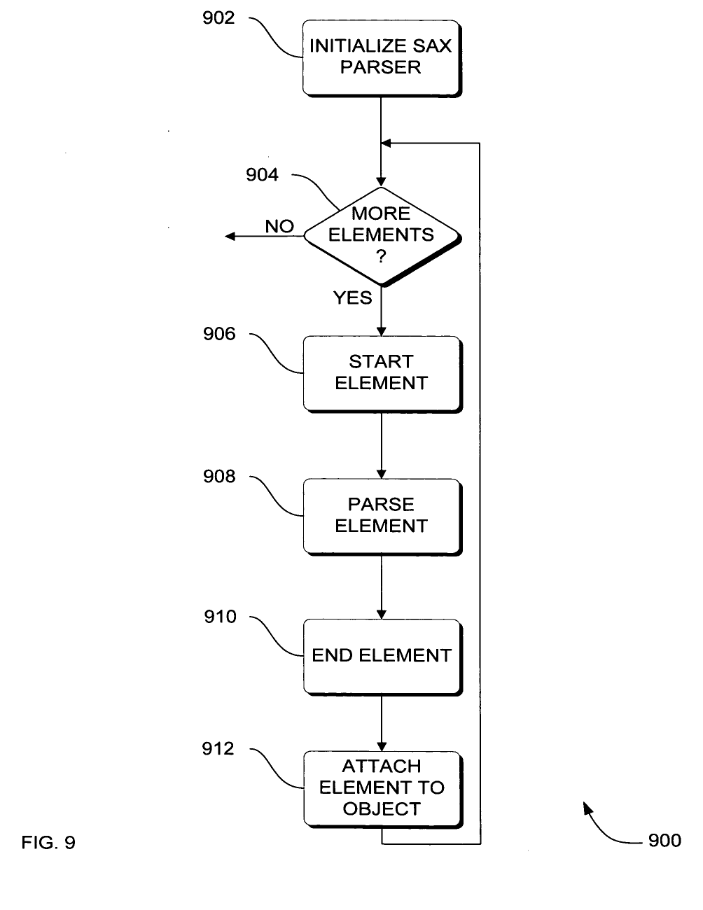

FIG. 9 is a flowchart of a method 900 of a parsing phase of a Java-based translator, according to an embodiment. Method 900 reduces the need for Java-to-C++ interfaces on the imaging system 100. Method 900 implements Java components, therefore no interface between components implement by method 900 and other Java components on system 100 is needed.

Method 900 includes initializing 902 a parser is that is compliant with the SAX standard. SAX is a standard for a serial access parser application program interface (API) for XML that is an acronym for “Simple API for XML.” The SAX-compliant parser manages XML information as a stream and is unidirectional, i.e. it cannot renegotiate a node without first having to establish a new handle to the document and reparse. The SAX standard is published by David Brownell of Megginson Technologies Ltd. In Ottawa, Canada. Alternatively, a parser that is compliant with the document object model (DOM) standard is used. The DOM standard is published by the World Wide Web Consortium (W3C), at the Massachusetts Institute of Technology, Laboratory for Computer Science. In some embodiments, initializing 902 the parser is invoked by an object of an ApdXmlParser class that serves to control the SAX parsing control for parsing an APD xml file as a subclass of class SAX org.xml.sax.helpers.DefaultHandler, which provides that SAX invokes it's startElement( ), endElement( ), characters( ), and error( ) object methods as it parses the XML.

If more elements in the non-procedural image annotation template 104 have not yet been parsed 904, parsing of the next element in the non-procedural image annotation template 104 starts 906. The ApdXmlParser object contains a nodeStack member variable that a startElement( ) object method pushes ApdNode objects onto a parse tree. The startElement( ) matches ApdNode factory through apdNodes. The apdNodes object is a string keyed hash of ApdNode objects. An object method startElement( ) extracts one of the instances, and attempt to construct one ApdNode object using an object method ApdNode.tryMatch( ).

The characters of the element are parsed 908. An object method characters( ) accumulates freetext which is saved as a string and is parsed into ApdExpNodes.

When all characters are parsed, the element is ended 910. The ApdXmlParser object contains a nodeStack member variable that a endElement( ) method pops ApdNode objects from the parse tree. When endElement( ) is invoked, the characters accumulated by characters( ) are parsed into ApdExpNode elements if the element is open. Whether or not the element is open, the nodeStack is popped indicating final construction of a given subtree. If the element was open, then the ApdExpNode tree is built using generated parsers that are compliant with Jlex/Cup. The cup parser in general creates the appropriate ApdExpNode using class constructors. Like yacc, Cup provides a stack to connect up the parse tree with.

Thereafter, the root node of the ApdExpNode is attached 912 to the current ApdSet object. After method 900 completes, method 1000 is performed.

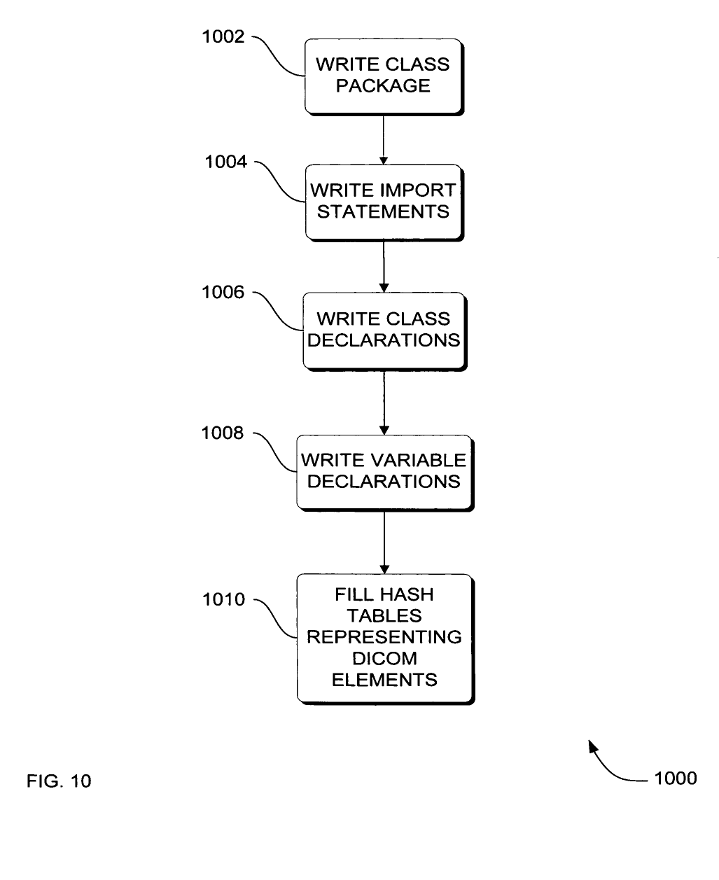

FIG. 10 is a flowchart of a method 1000 of a translating phase of a Java-based translator, according to an embodiment. Method 1000 is performed after method 900. The translating phase 1000 generates a file having Java source code, such as procedural image annotation source code 106 in FIG. 1.

Method 1000 includes writing 1002 a Java class package. Thereafter, method 1000 includes writing 1004 Java import statements. Subsequently, Java class declarations are written 1006.

Thereafter, method 1000 includes writing 1008 Java variable declarations. The variable declarations are written for each runtime, set, and DICOM variable that is used by an expression referenced by a layout. Writing declarations 1008 also creates special classes used for implementing type-safe get/set methods for runtime variables. Subsequently, method 1000 also includes filling 1010 hash tables representing DICOM elements. At the completion of method 1000, a file having Java source code that is suitable for compilation by a Java compiler, such as compiler 108 in FIG. 1 is complete.

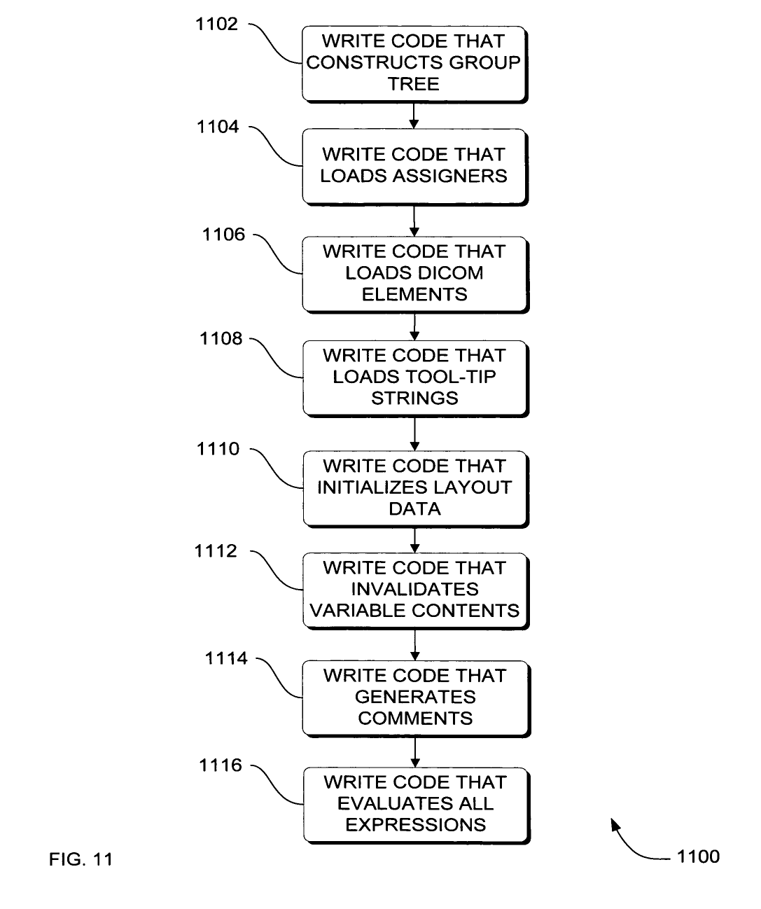

FIG. 11 is a flowchart of a method 1100 of filling 1010 hash tables representing DICOM elements in the translating phase method 1000 in FIG. 10, according to a Java-based translator embodiment.

Method 1100 includes writing 1102 code that constructs a group tree as described by, or as according to, the elements of the non-procedural image annotation template 104. Method 1100 also includes writing 1104 code that loads assigner attributes in an ApStyle object. The writing 1104 includes hashing with instances of run-time class declarations.

Method 1100 also comprises writing 1106 code that loads a data structure adapted for storage of DICOM elements with all DICOM elements that are required for annotation. Method 1100 further includes writing 1108 code that loads the data structure adapted for tool-tip data with character strings from a I18N object. Thereafter, data is ready for filling of hash tables that represent elements.

Method 1100 includes writing 1110 code that initializes a layout data structure that is designed to hold the annotation strings for each quadrant, line, and segment. Method 1100 furthermore includes writing 1112 code of a reset( ) method which invalidates all variable contents, as one would use if this object was assigned to control annotation of another image. Method 1100 also includes writing 1114 code that generates comments that document a Runtime Variable Updates object 614. Method 1100 also comprises writing 1116 code that evaluates all of the expressions in order of dependencies.

The Java-based methods 900, 1000 and 1100 reduce the need for Java-to-C++ interfaces on the imaging system, such as systems 200, 400 and 500 to support the annotation of images. Also, because the methods use Java, no interface between Java components based on methods 900, 1000 and 1100 and other Java components of systems imaging 200 is needed to support the annotation of images.

The system components of the development system 100, imaging system 200, medical imaging system 500, CT medical imaging system 600, classes 700 and 800 can be embodied as computer hardware circuitry or as a computer-readable program, or a combination of both. In another embodiment, development system 100, imaging system 200, methods 300 and 400, medical imaging system 500, CT medical imaging system 600, classes 700 and 800 are implemented in an application service provider (ASP) system.

More specifically, in the computer-readable program embodiment, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in computer 1202 in FIG. 12, or on at least as many computers as there are components.

### Hardware and Operating Environment

FIG. 12 is a block diagram of the hardware and operating environment 1200 in which different embodiments can be practiced. The description of FIG. 12 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

Computer 1202 includes a processor 1204, commercially available from Intel, Motorola, Cyrix and others. Computer 1202 also includes random-access memory (RAM) 1206, read-only memory (ROM) 1208, and one or more mass storage devices 1210, and a system bus 1212, that operatively couples various system components to the processing unit 1204. The memory 1206, 1208, and mass storage devices, 1210, are types of computer-accessible media. Mass storage devices 1210 are more specifically types of nonvolatile computer-accessible media and can include one or more hard disk drives, floppy disk drives, optical disk drives, and tape cartridge drives. The processor 1204 executes computer programs stored on the computer-accessible media.

Computer 1202 can be communicatively connected to the Internet 1214 via a communication device 1216. Internet 1214 connectivity is well known within the art. In one embodiment, a communication device 1216 is a modem that responds to communication drivers to connect to the Internet via what is known in the art as a “dial-up connection.” In another embodiment, a communication device 1216 is an Ethernet® or similar hardware network card connected to a local-area network (LAN) that itself is connected to the Internet via what is known in the art as a “direct connection” (e.g., T1 line, etc.).

A user enters commands and information into the computer 1202 through input devices such as a keyboard 1218 or a pointing device 1220. The keyboard 1218 permits entry of textual information into computer 1202, as known within the art, and embodiments are not limited to any particular type of keyboard. Pointing device 1220 permits the control of the screen pointer provided by a graphical user interface (GUI) of operating systems such as versions of Microsoft Windows® or Sun Microsystems Solaris®. Embodiments are not limited to any particular pointing device 1220. Such pointing devices include mice, touch pads, trackballs, remote controls and point sticks. Other input devices (not shown) can include a microphone, joystick, game pad, satellite dish, scanner, or the like.

In some embodiments, computer 1202 is operatively coupled to a display device 1222. Display device 1222 is connected to the system bus 1212. Display device 1222 permits the display of information, including computer, video and other information, for viewing by a user of the computer. Embodiments are not limited to any particular display device 1222. Such display devices include cathode ray tube (CRT) displays (monitors), as well as flat panel displays such as liquid crystal displays (LCD's). In addition to a monitor, computers typically include other peripheral input/output devices such as printers (not shown). Speakers 1224 and 1226 provide audio output of signals. Speakers 1224 and 1226 are also connected to the system bus 1212.

Computer 1202 also includes an operating system (not shown) that is stored on the computer-accessible media RAM 1206, ROM 1208, and mass storage device 1210, and is and executed by the processor 1204. Examples of operating systems include Microsoft Windows®, Apple MacOS®, Linux®, UNIX® and Sun Microsystems Solaris®. Examples are not limited to any particular operating system, however, and the construction and use of such operating systems are well known within the art.

Embodiments of computer 1202 are not limited to any type of computer 1202. In varying embodiments, computer 1202 comprises a PC-compatible computer, a MacOS®-compatible computer, a Linux®-compatible computer, or a UNIX®-compatible computer. The construction and operation of such computers are well known within the art.

Computer 1202 can be operated using at least one operating system to provide a graphical user interface (GUI) including a user-controllable pointer. Computer 1202 can have at least one web browser application program executing within at least one operating system, to permit users of computer 1202 to access intranet or Internet world-wide-web pages as addressed by Universal Resource Locator (URL) addresses. Examples of browser application programs include Netscape Navigator® and Microsoft Internet Explorer®.

The computer 1202 can operate in a networked environment using logical connections to one or more remote computers, such as remote computer 1228. These logical connections are achieved by a communication device coupled to, or a part of, the computer 1202. Embodiments are not limited to a particular type of communications device. The remote computer 1228 can be another computer, a server, a router, a network PC, a client, a peer device or other common network node. The logical connections depicted in FIG. 12 include a local-area network (LAN) 1230 and a wide-area network (WAN) 1232. Such networking environments are commonplace in offices, enterprise-wide computer networks, intranets and the Internet.

When used in a LAN-networking environment, the computer 1202 and remote computer 1228 are connected to the local network 1230 through network interfaces or adapters 1234, which is one type of communications device 1216. Remote computer 1228 also includes a network device 1236. When used in a conventional WAN-networking environment, the computer 1202 and remote computer 1228 communicate with a WAN 1232 through modems (not shown). The modem, which can be internal or external, is connected to the system bus 1212. In a networked environment, program modules depicted relative to the computer 1202, or portions thereof, can be stored in the remote computer 1228.

Computer 1202 also includes power supply 1238. Each power supply can be a battery.

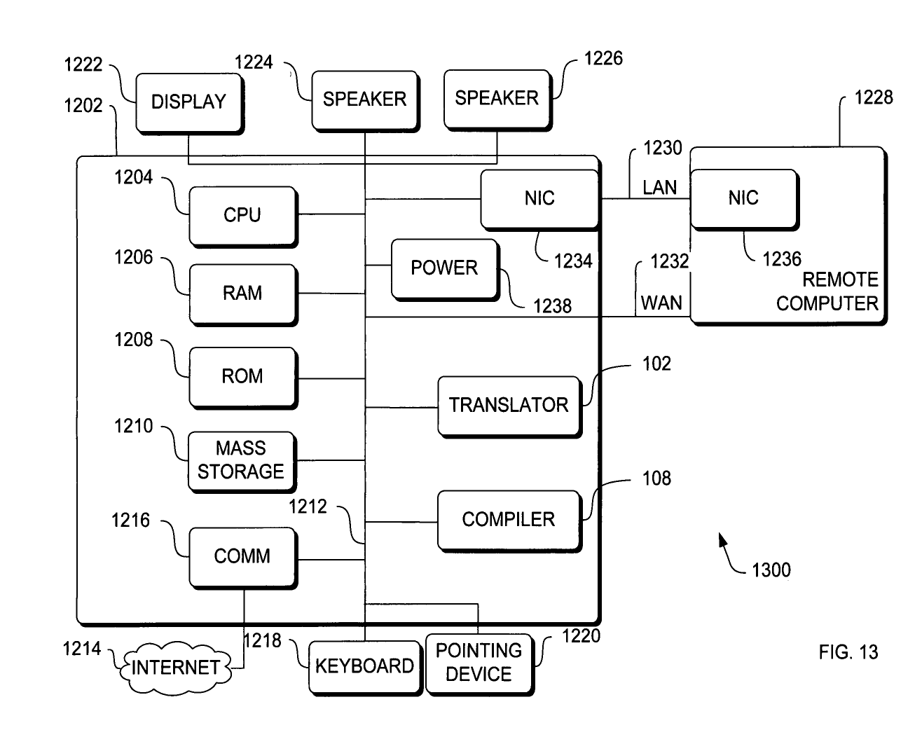

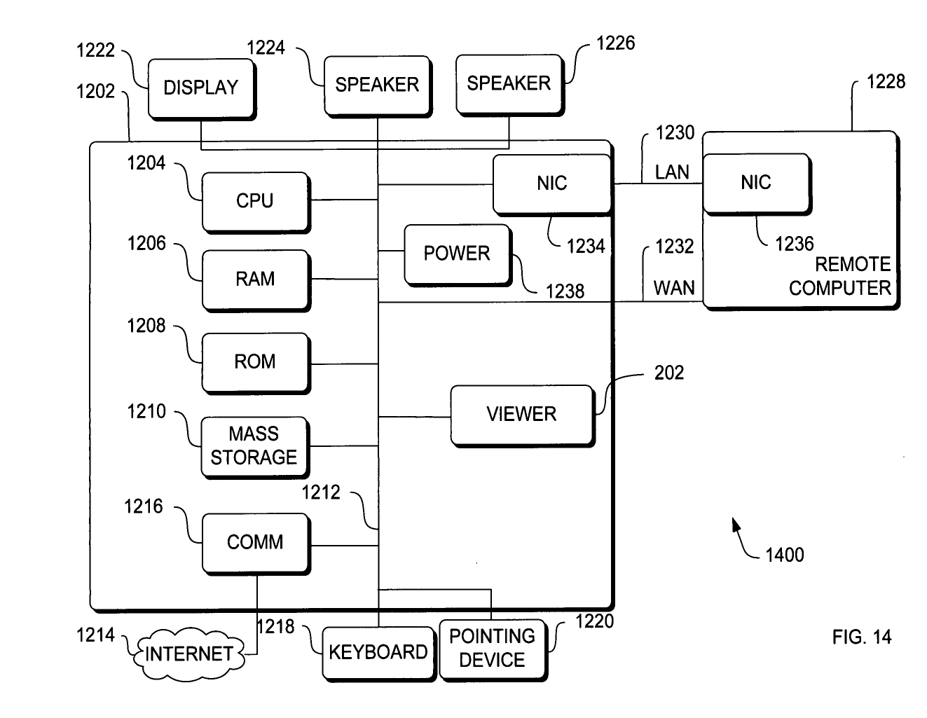

FIG. 13 is a block diagram of a development system 1300 implemented on hardware and operating environment 1200. System 1300 is an implementation of development system 100 in FIG. 1 on computer system 1202 in FIG. 12.

System 1300 includes a translator 102 and a compiler 108. The translator 102 translates the non-procedural image annotation template 104 into procedural image annotation source code 106; thereafter, the compiler 108 compiles the procedural image annotation source code 106 into an annotation presentation description (APD) 110 having computer instructions that are native to an imaging system, such 200 or 1400. Thus annotation calculations and operations and can be performed by the processor of imaging system 200 or system 1400 without run-time interpretation. Therefore, system 1300 reduces the need for run-time interpreters of source code on imaging system 200 or 1400 to support the annotation of images.

FIG. 14 is a block diagram of an imaging system 1400 implemented on hardware and operating environment 1200. System 1400 is an implementation of imaging system 200 in FIG. 2.

System 1400 includes an image viewer 202 that invokes execution of annotation instructions the APD 110 are that native to system 1400, to annotate image 204 using data from the image annotation object 206, to create annotated image 210.

In system 1400, the native annotation computer instructions in APD 110 do not need to be interpreted by system 1400 before execution. Accordingly, the imaging system 1400 does not require a run-time interpreter to execute the annotation calculations and operations. The need to rewrite the viewer 202 to include annotation calculations and operations is reduced by packaging the annotation calculations and operations in APD 110. Changes in annotation calculations and operations packaged in APD 110 for ready execution by system 1400 without changes to viewer 202, more readily and conveniently allows for consistent deployment of annotation calculations and operations among medical imaging systems.

### CONCLUSION

An image annotation system has been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations. For example, although described in object-oriented terms, one of ordinary skill in the art will appreciate that implementations can be made in a procedural design environment or any other design environment that provides the required relationships.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

The terminology used in this application is meant to include all object-oriented, database and communication environments and alternate technologies which provide the same functionality as described herein.

1. A computer-accessible medium comprising:
a translator that is operable to receive a non-procedural image annotation template, the translator being operable to translate the non-procedural image annotation template to image annotation source code; and
a compiler operably coupled to the translator, the compiler being operable to receive the image annotation source code and to compile the source code into an image annotation executable.

2. The computer-accessible medium of claim 1, wherein the non-procedural image annotation template further comprises a mixture of XML and conventional numerical expressions based on C language syntax.

3. The computer-accessible medium of claim 1, wherein the image annotation executable further comprises an annotation presentation description.

4. The computer-accessible medium of claim 1, wherein the translator further comprises:
an iterator object for an expression tree of the non-procedural image annotation template; and
a lexical analyzer of the procedural image annotation template.

5. The computer-accessible medium of claim 1, wherein the image annotation source code further comprises an object-oriented image annotation source code and the compiler further comprises an object-oriented compiler.

6. The computer-accessible medium of claim 5, wherein the object-oriented image annotation source code further comprises Java image annotation source code and the object-oriented compiler further comprises a Java compiler.

7. The computer-accessible medium of claim 1, wherein the image annotation executable further comprises instructions that are native to the processor of a medical imaging system.

8. A computer-accessible medium having executable instructions to generate an image annotation executable from a non-procedural image annotation template to annotate images, the executable instructions capable of directing a processor to perform:
translating the non-procedural image annotation template to image annotation source code, wherein non-procedural image annotation template comprises non-procedural expression of calculations and operations to annotate an image with embedded text and wherein the procedural image annotation source code comprises procedural expression of the calculations and operations to annotate an image with embedded text; and
compiling the image annotation source code into an image annotation executable.

9. The computer-accessible medium of claim 8, wherein the compiling further comprises:
targeting the compiling to an instruction set of a processor of an imaging system.

10. The computer-accessible medium of claim 8, further comprising executable instructions capable of directing a processor to perform:
transferring the image annotation executable to an imaging system.

11. The computer-accessible medium of claim 10, wherein the imaging system is a medical imaging system.

12. The computer-accessible medium of claim 8, wherein the non-procedural image annotation template is written in a language that does not require procedural operations and wherein the procedural image annotation source code further comprises calculations and operations to annotate an image with embedded text.

13. A development system comprising:
means for translating the non-procedural image annotation template to image annotation source code, wherein non-procedural image annotation template comprises non-procedural expression of calculations and operations to annotate an image with embedded text and wherein the procedural image annotation source code comprises procedural expression of the calculations and operations to annotate the image with the embedded text; and
means for compiling the image annotation source code into a medical image annotation executable, to an instruction set of a processor of an medical imaging system.

14. The development system of claim 13, further comprising:
means for transferring the image annotation executable to an imaging system.

15. The development system of claim 13, wherein the non-procedural image annotation template is written in a language that does not require procedural operations and wherein the procedural image annotation source code further comprises calculations and operations to annotate an image with embedded text.

16. A translator recorded on a computer-accessible medium, the translator being operable to receive a non-procedural image annotation template and to translate the non-procedural image annotation template to Java source code, the translator comprising:
a parser of the non-procedural image annotation template; and
a translator of the parsed non-procedural image annotation template to the Java source code.

17. The translator of claim 16, wherein the parser of the non-procedural image annotation template further comprises:
an initiator of a parser of the non-procedural image annotation template, the parser being compliant with the Simple API for XML standard;
an element starter;
an element parser;
an element ender; and
an element attacher.

18. The translator of claim 16, wherein the translator of the parsed non-procedural image annotation template further comprises:
a writer of Java class package source code;
a writer of Java import statement source code;
a writer of Java class declaration source code;
a writer of Java variable declaration source code; and
a filler of hash table representing at least one DICOM element of the Java source code.

19. The translator of claim 18, wherein the filler of hash tables representing elements of the Java source code further comprises:
a writer of Java source code that constructs a group tree as described by the elements of the non-procedural image annotation template;
a writer of Java source code that loads assigner attributes in an ApStyle object and hashes with instances of run-time class declarations;
a writer of Java source code that loads a data structure adapted for storage of DICOM elements with all DICOM elements that are required for annotation;
a writer of Java source code that loads the data structure adapted for tool-tip data with character strings;
a writer of Java source code that initializes a layout data structure that is designed to hold annotation strings for each quadrant, line, and segment;
a writer of Java source code that invalidates all variable contents, as one would use if this object was assigned to control annotation of another image;
a writer of Java source code that generates comments that document a runtime variable updates object; and
a writer of Java source code that evaluates expressions in order of dependencies.

20. A computer-accessible medium having executable instructions to translate a non-procedural image annotation template to Java source code, the executable instructions capable of directing a processor to perform:
parsing the non-procedural image annotation template comprising
initializing a parser of the non-procedural image annotation template, the parser being compliant with the Simple API for XML standard;
starting an element of the non-procedural image annotation template;
parsing an element of the of the non-procedural image annotation template using the parser;
ending an element of the non-procedural image annotation template; and
attaching the parsed element,
repeating the starting, parsing, ending and attaching for each element of the non-procedural image annotation template, yielding a parsed non-procedural image annotation template,
the translating further comprising:
translating the parsed non-procedural image annotation template to Java source code.

21. The computer-accessible medium of claim 20, wherein the translating of the parsed non-procedural image annotation template further comprises:
writing a Java class package;
writing Java import statements;
writing Java class declarations;
writing Java variable declarations; and
filling hash tables representing DICOM elements of the Java source code.

22. The computer-accessible medium of claim 20, wherein the non-procedural image annotation template further comprises a mixture of XML and conventional numerical expressions based on C language syntax.

23. A method to translate a non-procedural image annotation template to Java source code, the translator comprising:
parsing the non-procedural image annotation template comprising
initializing a parser of the non-procedural image annotation template, the parser being compliant with the Simple API for XML standard;
starting an element of the non-procedural image annotation template;
parsing an element of the of the non-procedural image annotation template using the parser;
ending an element of the non-procedural image annotation template; and
attaching the parsed element,
repeating the starting, parsing, ending and attaching for each element of the non-procedural image annotation template, yielding a parsed non-procedural image annotation template,
the translating further comprising:
translating the parsed non-procedural image annotation template to Java source code.

24. The method of claim 23, wherein the translating of the parsed non-procedural image annotation template further comprises:
writing a Java class package;
writing Java import statements;
writing Java class declarations;
writing Java variable declarations; and
filling hash tables representing DICOM elements of the Java source code.

25. The method of claim 23, wherein the non-procedural image annotation template further comprises a mixture of XML and conventional numerical expressions based on C language syntax.

26. A Java-based system comprising:
means for parsing the non-procedural image annotation template comprising:
means for initializing a parser of the non-procedural image annotation template, the parser being compliant with the Simple API for XML standard;
means for starting an element of the non-procedural image annotation template;
means for parsing an element of the of the non-procedural image annotation template using the parser;
means for ending an element of the non-procedural image annotation template; and
means for attaching the parsed element, means for repeating the starting, parsing, ending and attaching for each element of the non-procedural image annotation template, yielding a parsed non-procedural image annotation template,
the Java-based system further comprising means for translating comprising:
means for writing a Java class package;
means for writing Java import statements;
means for writing Java class declarations;
means for writing Java variable declarations; and
means for filling hash tables representing DICOM elements of Java source code.

27. The Java-based system of claim 26, wherein the non-procedural image annotation template further comprises a mixture of XML and conventional numerical expressions based on C language syntax.

28. A computer-accessible medium comprising:
a template repository that is operable to store one or more non-procedural image annotation templates;
a storer of the one or more non-procedural image annotation templates, operably coupled to the template repository; and
a selector of the one of the non-procedural image annotation templates, operably coupled to the template repository.

29. The computer-accessible medium of claim 28, wherein the one or more non-procedural image annotation templates further comprises a computed tomography non-procedural image annotation template.

30. The computer-accessible medium of claim 27, wherein the one or more non-procedural image annotation templates further comprises a magnetic-resonance non-procedural image annotation template.

31. A computer-accessible medium having executable instructions to generate an image annotation executable from a non-procedural image annotation template to annotate images, the executable instructions capable of directing a processor to perform:
storing the one or more non-procedural image annotation templates in a template repository, and
selecting one of the non-procedural image annotation templates in the template repository.

32. The computer-accessible medium of claim 31, wherein the one or more non-procedural image annotation templates further comprises a computed tomography non-procedural image annotation template.

33. The computer-accessible medium of claim 31, wherein the one or more non-procedural image annotation templates further comprises a magnetic-resonance non-procedural image annotation template.

34. A computer-accessible medium comprising:
an image annotation executable; and
an image viewer, operable to receive the image annotation executable, an image and an image annotation object, the image annotation object containing text, the image viewer being operable to execute instructions contained in the image annotation executable and using text from the image annotation object, and the image viewer being operable to generate an annotated image that is annotated with the text from the image annotation object.

35. The computer-accessible medium of claim 34, wherein the instructions further comprise computer instructions that are native to a processor, the processor being operably coupled through a bus to the computer-accessible medium.

36. The computer-accessible medium of claim 34, wherein the image annotation executable further comprises an image annotation executable that is compiled from a non-procedural image annotation template.

37. The computer-accessible medium of claim 34, wherein the image annotation executable further comprises an annotation presentation description.

38. The computer-accessible medium of claim 34, wherein the image annotation object further comprises the image.

39. The computer-accessible medium of claim 37, wherein the image annotation object further comprises an image annotation object that conforms to standard that defines data elements in object-oriented terms, each object having a unique tag, name, characteristics and semantics.

40. The computer-accessible medium of claim 34, wherein the image further comprises an unannotated image.

41. The computer-accessible medium of claim 34, wherein the image annotation executable further comprises:
an object to select a style class object that is appropriate for imaging of a modality; and
an instantiated style class object.

42. The computer-accessible medium of claim 41, wherein the modality is selected from a group consisting of magnetic resonance, computed tomography, X-ray, ultrasound and positron emission tomography.

43. The computer-accessible medium of claim 41, wherein the viewer further comprises:
an object to invoke one or more methods in the object that selects a style class object that is appropriate for imaging of a modality; and
an object to receive parsed annotation data and the image from the image annotation object through a host image annotation parser, and to forward the image and text to the style class object that is appropriate for imaging of a modality.

44. The computer-accessible medium of claim 43, wherein the style class object that is appropriate for imaging of a modality further comprises:
a method to forward the image and text to a host text drawer in the viewer; and
a method to forward the image and text to a graphic utilities object that is native to an operating system that is running on a processor that is operably coupled to the computer-accessible medium, whereupon the graphic utilities object is to generate the annotated image.

45. A computer-accessible medium having executable instructions to generate and view an annotated medical image, from an image annotation object and an annotation presentation description, the image annotation object having an image, the annotation presentation description having instructions that are native to a processor that is operably coupled to the computer accessible medium, the executable instructions capable of directing the processor to perform:
receiving the annotation presentation description and the image annotation object; and
invoking the native instructions contained in the annotation presentation description and using text from the image annotation object, to generate and view the annotated medical image that is annotated with the text from the image annotation object.

46. The computer-accessible medium of claim 45, wherein the annotation presentation description further comprises an annotation presentation description that is compiled from a non-procedural image annotation template.

47. The computer-accessible medium of claim 45, wherein the image annotation object further comprises an image annotation object that conforms to standard that defines data elements in object-oriented terms, each object having a unique tag, name, characteristics and semantics.

48. The computer-accessible medium of claim 45, wherein the annotation presentation description further comprises executable instructions capable of directing the processor to perform:
selecting a style class object that is appropriate for imaging of a modality; and
instantiating the selected style class object.

49. The computer-accessible medium of claim 48, wherein the modality is selected from a group consisting of magnetic resonance, computed tomography, X-ray, ultrasound and positron emission tomography.

50. The computer-accessible medium of claim 45, wherein the executable instructions further comprise executable instructions capable of directing the processor to perform:
receiving parsed annotation data and the image from the image annotation object through a host image annotation parser; and
forwarding the image and text to a graphic utilities object that is native to an operating system that is running on the processor, whereupon the graphic utilities object is to generate and view the annotated image.

51. A method to generate and view an annotated medical image, from an image annotation object having an image and an annotation presentation description, wherein the annotation presentation description further comprises an annotation presentation description that is compiled from a non-procedural image annotation template and has instructions that are native to a processor that is operably coupled to the computer accessible medium, the method comprising:
receiving the annotation presentation description and the image annotation object, the image annotation object containing text; and
invoking the native instructions contained in the annotation presentation description and using text from the image annotation object, to generate and view the annotated medical image that is annotated with the text from the image annotation object.

52. The method of claim 51, wherein the image annotation object further comprises an image annotation object that conforms to the Digital Imaging and Communications in Medicine standard.

53. The method of claim 51, further comprising:
selecting a style class object that is appropriate for imaging of a modality, wherein the modality is selected from a group consisting of magnetic resonance, computed tomography, X-ray, ultrasound and positron emission tomography; and
instantiating the selected style class object.

54. The method of claim 51, further comprising:
receiving parsed annotation data and the image from the image annotation object through a host image annotation parser; and
forwarding the image and text to a graphic utilities object that is native to an operating system that is running on the processor, whereupon the graphic utilities object is to generate the annotated image.

55. A Java-based system to generate and view an annotated medical image, from an annotation presentation description and an annotation object, wherein the annotation object conforms to the Digital Imaging and Communications in Medicine standard and has an image, wherein the annotation presentation description further comprises an annotation presentation description compiled from a non-procedural image annotation template and has instructions that are native to a processor, the system comprising:
Java-based means for receiving the annotation presentation description and the image annotation object, the image annotation object containing text; and
Java-based means for invoking the native instructions contained in the annotation presentation description and using text from the image annotation object, to generate and view the annotated medical image that is annotated with the text from the image annotation object.

56. The Java-based system of claim 55, further comprising:
Java-based means for selecting a style class object that is appropriate for imaging of a modality, wherein the modality is selected from a group consisting of magnetic resonance, computed tomography, X-ray, ultrasound and positron emission tomography;
Java-based means for instantiating the selected style class object;
Java-based means for receiving parsed annotation data and the image from the image annotation object through a host image annotation parser; and
Java-based means for forwarding the image and text to a graphic utilities object that is native to an operating system that is running on the processor, whereupon the graphic utilities object is to generate the annotated image.

57. A computer system comprising:
a processor;
a bus operably coupled to the processor and
a computer-accessible medium comprising a viewer that is operable to access computer instructions that are native to the processor, the computer instructions having been generated by a processor on another computer system, the computer-accessible medium being operably coupled to the processor through the bus.

58. The computer system of claim 57, wherein the viewer further comprises a browser and the computer instructions further comprise computer instructions encapsulated in a browser plug-in component.

59. A computed tomography imaging system comprising:
a processor;
a bus operably coupled to the processor and
a computer-accessible medium comprising a viewer that is operable to access:
objects that conform to the Digital Imaging and Communications in Medicine standard, the objects comprising an image and an annotation presentation description; and
computer instructions that are native to the processor, the computer instructions having been generated by a processor on another system, the computer-accessible medium being operably coupled to the processor through the bus.

60. The computed tomography imaging system of claim 59, wherein the viewer further comprises a browser and the computer instructions further comprise computer instructions encapsulated in a browser plug-in component.

61. The computer system of claim 59, wherein the computer instructions further comprise computer instructions encapsulated in a dynamic link library.

62. A computer-accessible medium comprising:
an encapsulation of image annotation computer instructions; and
a viewer that is operable to access the encapsulated image annotation computer instructions.

63. The computer-accessible medium of claim 62 wherein the encapsulated image annotation computer instructions further comprise arithmetic calculations and special string operations for annotation that are native to a processor that is operably coupled to the computer-accessible medium.

64. A computer-accessible medium having executable instructions to generate an annotated image, the executable instructions capable of directing a processor to perform:
invoking executable instructions that are native to the processor, the executable instructions being contained in an image annotation executable, wherein operands to the native computer instructions include text; and
generating an annotated image that is annotated with the text from the image annotation object.

65. The computer-accessible medium of claim 64, wherein the executable instructions further comprise executable instructions capable of directing the processor to perform displaying the annotated image on a visual display in a browser.

66. The computer-accessible medium of claim 65, wherein the image annotation object further comprises an object that is encoded according to a standard that defines data elements in object-oriented terms, each object having a unique tag, name, characteristics and semantics.

67. The computer-accessible medium of claim 65, wherein the original image further comprises an original unannotated medical image.

68. The computer-accessible medium of claim 65, wherein the original image further comprises an original image contained with the image annotation object.

69. The computer-accessible medium of claim 65, wherein the image annotation executable further comprises an annotation presentation description.

70. A computer-accessible medium having executable instructions to generate an annotated medical image, an image annotation object and an annotation presentation description, the executable instructions capable of directing a processor to perform:
invoking executable instructions that are native to the processor, the executable instructions being contained in the annotation presentation description, operands to the native computer instructions including text, the image annotation object being encoded according to a standard that defines data elements in object-oriented terms, the image annotation object having a unique tag, name, characteristics and semantics;
annotating an original medical image with the text from the image annotation object; and
displaying the annotated image on a visual display.

71. The computer-accessible medium of claim 70, wherein the executable instructions further comprise annotation calculations and operations.

72. The computer-accessible medium of claim 70, wherein the displaying further comprises a displaying the annotated image in a browser.

73. The computer-accessible medium of claim 70, wherein the processor further comprises a processor of a medical imaging device.

74. The computer-accessible medium of claim 70, wherein the original image further comprises an original image contained with the image annotation object.

75. An apparatus comprising:
a processor; and
an encapsulation of image annotation computer instructions, the computer instructions being native to the processor, the computer instructions being generated by a processor on another apparatus.

76. A method of updating a medical imaging system with new annotation calculations, the method comprising:
generating on a development system an image annotation executable that includes computer instructions that are native to a processor of the medical imaging system; and
forwarding the image annotation executable through the Internet to the medical imaging system.

77. The method of claim 76, wherein the image annotation executable further comprises an image annotation executable that package is a form selected from the group consisting of a browser-plugin and a dynamic link library.

78. A method of updating a medical imaging system with new annotation calculations, the method comprising:
receiving an image annotation executable that includes computer instructions of the new annotation calculations that are native to a processor of the medical imaging system; and
storing the image annotation executable in a location that is accessible to a viewer that is enable to access the image annotation executable.

79. The method of claim 78, wherein receiving further comprises:
receiving the image annotation executable from a manufacturer of the medical imaging system.

80. The method of claim 78, wherein the medical imaging system further comprises a computer tomography medical imaging system.

81. The method of claim 78, wherein the medical imaging system further comprises a magnetic imaging medical imaging system.
